(19) United States
(12) Patent Application Publication
(10) Pub. No.: US 2013/0311550 A1
(43) Pub. Date: Nov. 21, 2013

(54) Multi-site Server and Client Resynchronization Process and Devices

(71) Applicant: Infinite Convergence Solutions, Inc, Arlington Heights, IL (US)

(72) Inventor: Tharusha Cumaranatunge, Palatine, IL (US)

(73) Assignee: INFINITE CONVERGENCE SOLUTIONS, INC, Arlington Heights, IL (US)

(21) Appl. No.: 13/892,095

(22) Filed: May 10, 2013

Related U.S. Application Data
(60) Provisional application No. 61/648,517, filed on May 17, 2012.

(51) Int. Cl. H04L 29/06

(52) U.S. Cl. CPC H04L 29/06047
USPC 709/203

(57) ABSTRACT

This method relates to efficient message server database synchronization specifically including synchronization of databases containing email and short text messages. Client and server devices which support this message synchronization are also described.

### FIELD OF THE INVENTION

This relates to Electronic Message server database synchronization including email and cellular short text messages, cellular multi-media messages, as well as to mobile and other wireless client devices which support this novel message synchronization process to multiple message servers.

### BACKGROUND OF THE INVENTION

The POP protocol, well known to those in the art, provides a synchronization method of electronic messages between a single server and a client device.

In addition, in RFC3501 and RFC 4551, the Internet Engineering Task Force (IETF) published the Internet Message Access Protocol (IMAP) as well as the IMAP Extension for Conditional STORE Operation or Quick Flag Changes Resynchronization that addresses synchronization between multiple clients and a single messaging server. Most of the current art addresses the problem of synchronization of a single or multiple client devices to a single common server. In order to ensure high network availability, however, it is necessary in many networks, especially, but not limited to financial and telecommunications networks, to have multiple replicated database servers stored at separate physical locations in “Active-Active” configuration where multiple servers are in concurrent use, but they are synchronized via data replication. In an asynchronous multi-server environment, multiple servers can receive different message updates simultaneously or updates to one server while one or more of the other servers are not accessible. In order to maintain a high availability network, changes require asynchronous replication to at least one mirrored server. (If synchronous replication were used by the network, an outage of a mirrored server would imply an outage of the entire network, thus an asynchronous replication method between mirrored servers is required to maintain high availability.) A typical use case in such a configuration is, in the absence of failures, to have one geographic location serve a portion of clients based on subscriber mobile directory numbers and another location providing service to the remainder of the clients. Each location has a collection of servers, but the locations may not necessarily be geographically separate. The servers synchronize data amongst themselves using asynchronous replication methods. Once one or more servers at a location fails, the client can fail-over to the other group of servers and not have a service interruption. The fail-over to the other set of servers is done transparently to the client by using common methods, such as DNS or load balancers. An inherent problem of asynchronously replicated data on servers is that contents may not be exactly identical between (nearly) replicated servers at any given point of time.

These database differences could be due to complete server failure, incomplete restoral of one of the servers after a server failure , timing of the replication, or other reasons which result in data which may not be exactly equivalent as intended between two or more active database servers. This synchronization problem is not adequately addressed by the existing arts. Under the current IETF published art for a multi-server scenario, the UIDValidity is not necessarily the same between the servers. Because of this, clients often detect a mailbox difference between the servers and have to repeatedly resynchronize a large amount of data (e.g. the entire mailbox stored on the server for that particular client). This inefficiency results in higher transaction costs for both the client and server, higher network traffic than necessary, as well as additional power consumption for messaging clients. In many cases, such as for cellular operators, the messaging clients are mobile phones or tablet devices where conserving battery life is a paramount concern.

Other published art, US application 2012/0005283 by Nathan Provo, et al, addresses a multi-server email environment by use of additional network components, including a synchronization server and a synchronization proxy which has been found to add complexity to the network which is an important issue for network operators. In addition, the Provo method specifically does not store synchronization information on the email servers as stated in the independent claims of the Provo publication.

### SUMMARY OF INVENTION

This method uses a set of sequence numbers, labeled HIGHESTMCR by the inventor, comprising at least two server sequence numbers S1 and S2 to synchronize a multi-site message server database between multiple servers and one or more clients in an efficient method

This method has the advantage of preventing expensive resynchronization present in the prior art IMAP conditional store process, thereby conserving power on mobile and other client devices and reducing network bandwidth usage as compared to prior art. This also represents a simpler network configuration requiring fewer network components than is taught by prior art to perform synchronization.

### DRAWINGS—LIST OF REFERENCE NUMBERS

101 Primary Server

102 Client device

110 HIGHESTMCR values stored on primary server

121 UID database field stored on primary server

122 FLAGS database field on primary server

123 XMCR database field on primary server

151 Secondary Server

160 HIGHESTMCR values stored on secondary server

171 UID database field stored on secondary server

172 FLAGS database field on primary server

173 XMCR database field on secondary server

190 HIGHESTMCR values stored on Client device

291 Copy of UID 102 on secondary server

202 Copy of recently changed FLAGS record for UID 102 on secondary server only

203 Copy of MCR values for UID 102 which is now the highest MCR value for secondary server

260 Copy of HIGHESTMCR on secondary server

290 Copy of HIGHESTMCR on client

312 New value of HIGHESTMCR on primary server after restoral of primary server and replication with secondary server.

341 Updated UID on primary server after replication with secondary server

342 Updated FLAGS value on primary server after replication with secondary server

343 Updated MCR sequence numbers on primary server after replication with secondary server

410 New value of HIGHESTMCR on primary server after append to primary. Not yet replicated.

441 New UID appended on primary server

442 New FLAGS data appended on primary server

443 MCR value for appended data

460 New value of HIGHESTMCR on secondary server after update to secondary. Not yet replicated.

491 New UID appended on secondary server

492 New FLAGS data appended on secondary server

493 MCR value for appended data

510 New value of HIGHESTMCR on primary server after replication complete

541 New UID copied to Primary Server after replication with secondary

542 New FLAGs data copied to Primary after replication with secondary

543 MCR value for appended data

560 New value of HIGHESTMCR on secondary server after replication complete

591 New UID copied to secondary Server after replication with primary

592 New Flags data copied to secondary server after replication with primary

593 MCR value for appended data

### GLOSSARY

CHANGESINCEMCR Directive that synchronizes a client with most recent changes on a given server

CLIENT Used to accesses a remote service on another computer. In preferred embodiment it is an wireless message user agent used to access and manage a user's messages stored on multiple remote servers.

FLAGS A set of indicators for each message which show, for example if the message was Answered , Deleted, Read, etc. Changes to Flags or other message data are a modification which will increment one of the sequence numbers.

HIGHESTMCR A set of sequence numbers which indicate the most recently modified message on each of server.

IETF Internet Engineering Task Force

IMAP Internet Message Access Protocol

IP Internet Protocol

MCR Multi Client Resynchronization

POP Post Office Protocol

RFC IETF Request for Comments Document

S1 Sequence number corresponding to Server 1 (Primary Server)

S2 Sequence number corresponding to Server 2 (Secondary Server)

UID Unique Identifier for each message, assigned in a strictly ascending fashion but not necessarily contiguous.

UIDVALIDITY Unique identifier validity value as defined in RFC 3501. The unique identifier validity value is sent in a UIDVALIDITY response code in an OK untagged response at mailbox selection time. If unique identifiers from an earlier session fail to persist in this session, the unique identifier validity value MUST be greater than the one used in the earlier session.

XMCR an IMAP compatible field that holds MCR values for each message

### BRIEF DESCRIPTION OF DRAWINGS

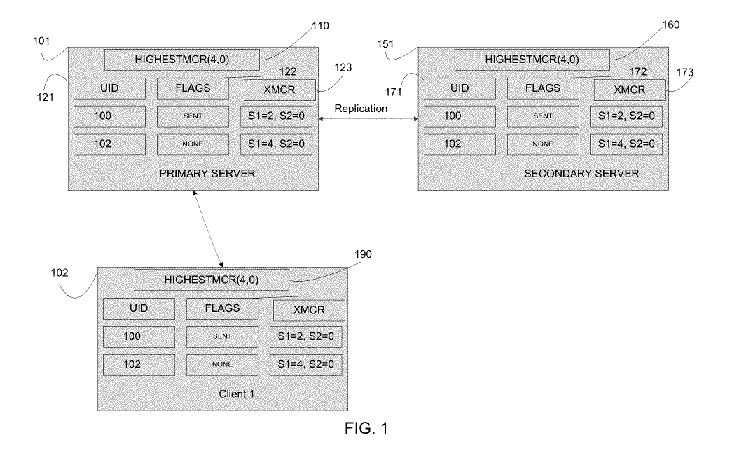

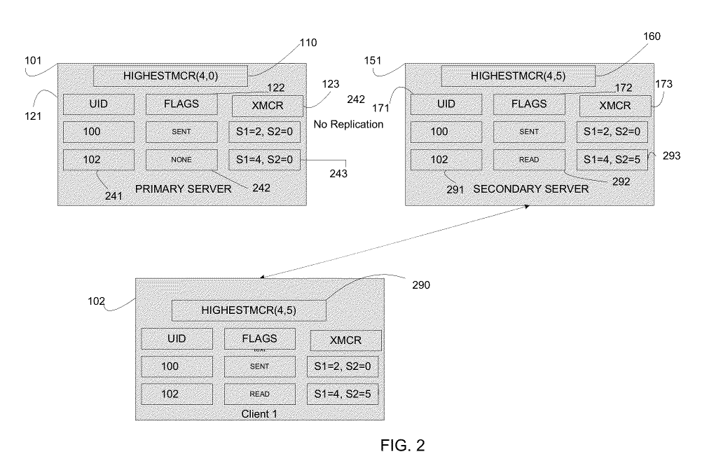

FIG. 1 shows the preferred embodiment, two message storage servers with a message client in normal configuration. The mailbox contents are perfectly synchronized between servers and client. Client and both servers have the same HIGHESTMCR values. FIG. 2 shows the case where the primary server is unavailable with replication suspended between servers. A client can access only the secondary server and receive HIGHESTMCR from secondary server and other data which matches secondary site. HIGHESTMCR on primary server is out of date.

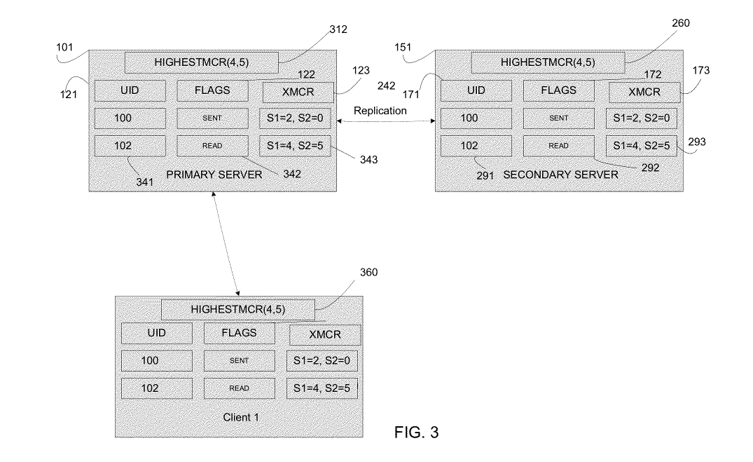

FIG. 3 shows restoration of the primary server with data replicated from secondary server. Clients can receive the same information from both servers

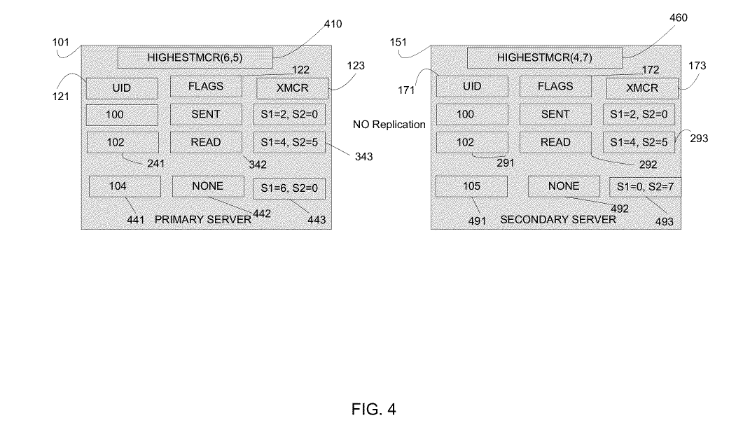

FIG. 4 shows both servers available, but a difference in data with different appends being made to both sites. HIGHESTMCR differs between servers.

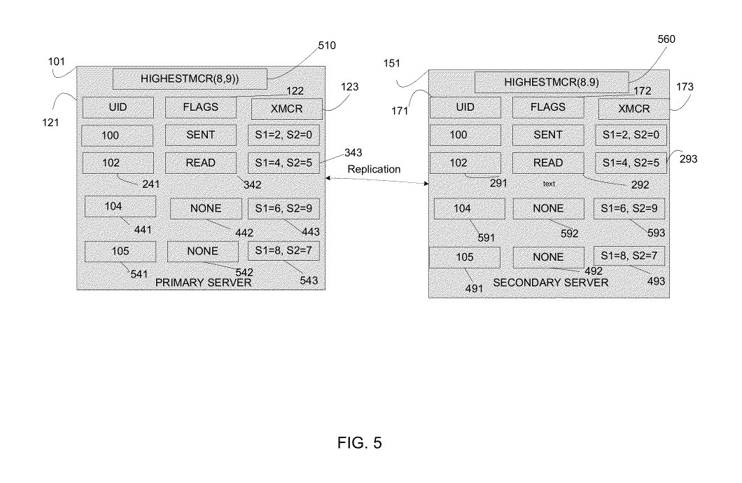

FIG. 5 shows both servers available and restored and appends made to both sites in FIG. 4 have now been replicated across sites.

### DETAILED DESCRIPTION

This invention uses a set of sequence numbers, labeled HIGHESTMCR by the inventor, comprising at least two server sequence numbers S1 and S2 to synchronize a multi-site message server database between multiple servers and one or more clients. In the preferred embodiment SI. corresponds to a sequence number for the primary server and S2 corresponds to a sequence number for the Secondary server. HIGHESTMCR is stored on all the servers as well as the clients, which indicates when the last known change occurred for each client mailbox stored on each server. The client also stores it's copy of HIGHESTMCR. HIGHESTMCR is returned by the server when the database is accessed by the client and can be compared to the client version of HIGHESTMCR. When a server receives a change to any of the information stored for a client, it increments the sequence number stored on the server associated with data stored on that server while maintaining the sequence number stored on the server for changes associated with the other servers.

To verify and synchronize the client data with one of the servers, the client performs a command to determine the server's HIGHESTMCR values and compares to the HIGHESTMCR stored on the client. If all the values are the same, no further action is required, the client is verified to be synchronized. If the client has a lower value of any sequence number that comprises HIGHESTMCR, the client issues a fetch with a new directive, referred to as CHANGESINCEMCR by the inventor, to request the HIGHESTMCR as well as the changed values from the server. The client updates its HIGHESTMCR values while processing fetch responses for the unsynchronized data from the server.

In the case of the client having a higher S1. or higher S2 value than the server, no further action is needed by the client as the client has at that point in time a more recent version of the database. The server will eventually synchronize when replication between server sites is restored.

In the method used in RFC 4551, the modsequence value used to track changes must be semantically identical between servers for the UIDValidity value to be kept same between servers. Since this is not possible in an environment where there is asynchronous replication, the UIDValidity value must be kept different between servers to ensure that the client can update its mailbox correctly. Using the method described here, the IMAP UIDValidity value remains synchronized between servers at all time which implies that client synchronization with multiple servers is not necessary. This method is an improvement over the existing IMAP conditional store process because , when the client detects a UIDValidity difference under the IMAP conditional store process, it requires additional client synchronization to other servers at added cost of network traffic and additional power depletion on the mobile client.

The method requires a Server apparatus to store the Multi-client Resynchronization (MCR) sequence numbers. (MCR is labeled XMCR in the message server database by the inventor in order to be compatible with the IMAP naming conventions for proprietary extensions.) The HIGHESTMCR sequence numbers associated with each client must also be stored on each server, and a comparison of those HIGHESTMCR values with the client device is necessary The servers must also support a new CHANGESINCEMCR directive to update the client with only the unsynchronized information.

This method also requires a client which will compare HIGHESTMCR with the server and also needs to support the CHANGESINCEMCR directive in order to fetch unsynchronized information.

Those skilled in the art will realize this method is not limited to IMAP message servers and can be extended to other multiple server/client configurations. Those skilled in the art will further realize this method can be extended to more than just two concurrent replicated servers and is also compatible with multiple concurrent clients.

What is claimed is:

1. A method to synchronize data between one or more clients and two or more message storage servers comprising:
a. storing two or more sequence numbers at each server and at the client;
b. receiving a change to data on one or more message storage servers;
c. recording a sequence number for the change on the server;
d. modifying, if necessary, the highest sequence number stored on the server while maintaining sequence numbers on said server for changes associated with other replicated servers;
e. comparing the highest sequence numbers stored at the client and the highest sequence numbers stored at one of the servers;
f. determining if a synchronization update is necessary at the client;
g. updating only the unsynchronized information.

2. A server apparatus which supports storage of two or more sequence numbers for each client of the server.

3. The server apparatus of claim 2 which compares its own sequence numbers with sequence numbers of a replicated server.

4. The server apparatus of claim 3 which supports a directive to update only the unsynchronized data with at least one replicated server.

5. The server apparatus of claim 2 which compares its own sequence numbers with sequence numbers of the client.

6. The server apparatus of claim 5 which supports a directive to update only the unsynchronized data to the clients.

7. A client apparatus which supports storage of a two or more sequence numbers to identify the unsynchronized data.

8. The client apparatus of claim 7 which compares its own sequence numbers with those of a server.

9. The client apparatus of claim 8 which supports a directive to update its database with only the unsynchronized data.

10. The client apparatus of claim 9 which is also a mobile communication device.

11. The client apparatus of claim 9 which is also a tablet device.
